(19) United States
(12) Patent Application Publication
(10) Pub. No.: US 2024/0278233 A1
(43) Pub. Date: Aug. 22, 2024

(54) DIAGNOSTIC PLATFORM

(71) Applicant: Regents of the University of Minnesota, Minneapolis, MN (US)

(72) Inventors: Tianhong Cui, Vadnais Heights, MN (US); Yang Wang, Beijing (CN); Peng Zhou, Minneapolis, MN (US); Mark John Osborn, Minneapolis, MN (US); Amber McElroy, Apple Valley, MN (US)

(21) Appl. No.: 18/443,963

(22) Filed: Feb. 16, 2024

Related U.S. Application Data
(60) Provisional application No. 63/485,720, filed on Feb. 17, 2023.

(51) Int. Cl. B01L 3/00; B01L 7/00

(52) U.S. Cl. CPC B01L 3/5023; B01L 7/525; B01L 2200/0689; B01L 2200/087; B01L 2300/041; B01L 2300/0663; B01L 2300/0681; B01L 2300/1805

(57) ABSTRACT

Systems, devices, and techniques are configured to detect disease from a biological sample. In one example, a diagnostic system includes a first housing portion defining an injection port, a first chamber configured to contain a first solution, a second chamber configured to contain a second solution, and a second housing portion defining at least one waste chamber configured to receive fluid from at least one of the first chamber or the second chamber. The system also includes a sliding panel comprising a sample chamber configured to contain a biological sample, wherein the sliding panel is positioned between the first housing portion and the second housing portion and configured to move the sample chamber to different positions corresponding to at least the first chamber and the second chamber of the first housing portion.

This application claims the benefit of and priority to U.S. Provisional Patent Application No. 63/485,720, filed Feb. 17, 2023, the entire contents of which is incorporated herein by reference.

### TECHNICAL FIELD

This disclosure generally relates to diagnostic devices, and, more particularly, to devices configured to detect the presence of a biological substance.

### BACKGROUND

Infectious disease detection can be performed using an array of different techniques depending on the disease. For example, some diseases, such as COVID-19, can be detected from a patient sample using polymerase chain reaction (PCR) based techniques. These PCR-based techniques amplify the amount of nucleic acid present in the given sample which can improve detection accuracy. Other techniques include antigen-based detection techniques.

### SUMMARY

Techniques, systems, and device configured for detecting diseases, such as infection diseases, are described. For example, a medical diagnostic device includes multiple chambers that can contain respective solutions supporting the extraction and amplification of a biological substance, such as nucleic acids, from the sample. The diagnostic device may include a panel configured to move the sample between the different chambers. In addition, the diagnostic device may include a heating element configured to heat the sample at target temperatures and/or using cycled heating in order to amplify the quantity of the biological substance within the sample chamber. Medical diagnostic devices described herein can be less expensive and more accurate than alternative diagnostic options, provide results visible to a user, and support operation by inexperienced users. In some examples, the medical diagnostic device may include an electrochemical sensor configured to detect a concentration of the biological substance, such as DNA, within the biological sample in the sample chamber.

In one example, a diagnostic system includes a first housing portion defining: an injection port; a first chamber configured to contain a first solution; and a second chamber configured to contain a second solution; a second housing portion defining at least one waste chamber configured to receive fluid from at least one of the first chamber or the second chamber; and a sliding panel comprising a sample chamber configured to contain a biological sample, wherein the sliding panel is: positioned between the first housing portion and the second housing portion; and configured to move the sample chamber to different positions corresponding to at least the first chamber and the second chamber of the first housing portion.

In one example, a method includes inserting a biological sample into a sample chamber of a diagnostic system, wherein the diagnostic system comprises: a first housing portion defining: an injection port; a first chamber configured to contain a first solution; and a second chamber configured to contain a second solution; a second housing portion defining at least one waste chamber configured to receive fluid from at least one of the first chamber or the second chamber; and a sliding panel comprising the sample chamber configured to contain the biological sample, wherein the sliding panel is positioned between the first housing portion and the second housing portion and configured to move the sample chamber to different positions corresponding to at least the first chamber and the second chamber of the first housing portion. The example method also includes moving the sliding panel such that the sample chamber comes in contact with the first solution of the first chamber; moving the sliding panel such that the sample chamber comes in contact with the second solution of the second chamber; and positioning the sliding panel to expose the sample chamber for user viewing of a diagnostic result indicated by the sample chamber.

In one example, a diagnostic device includes a first housing portion defining: an injection port configured to accept a biological sample; a first chamber configured to contain a wash buffer; and a second chamber configured to contain a LAMP buffer; a third chamber configured to contain a running buffer; a second housing portion defining at least one waste chamber configured to receive fluid from the first chamber, the second chamber, and the third chamber; a graphene heating element carried on the second housing portion; and a sliding panel comprising a sample chamber configured to receive the biological sample via the injection port, wherein the sliding panel is: positioned between the first housing portion and the second housing portion; and configured to move the sample chamber to different positions corresponding to at least the first chamber and the second chamber of the first housing portion, wherein the diagnostic device is configured to complete a diagnostic indication of a presence of a biological substance within the biological sample.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a conceptual diagram illustrating an example medical diagnostic device as described herein.

FIG. 1B is an exploded view of the example medical diagnostic device of FIG. 1A.

FIG. 1C is a conceptual view of a sample applied to filter paper in an injection port.

FIG. 1D is a cross-sectional view of the example medical diagnostic device of FIG. 1A.

FIG. 2A is a conceptual diagram illustrating an example medical diagnostic device as described herein.

FIG. 2B is an exploded view of the example medical diagnostic device of FIG. 2A.

FIG. 2C is a cross-sectional view of the example medical diagnostic device of FIG. 2A.

FIG. 2D is a conceptual diagram of a laser-induced generation of a graphene heating element.

FIG. 2E is a graph of an example PCR process executed by the example medical diagnostic device of FIG. 2A.

FIGS. 2F and 2G are an exploded view and cross-sectional view of an example graphene heating element and example chamber to be heated.

FIG. 2H includes different magnification images of a laser induced graphene layer for a heating element.

FIG. 3 is a diagram of an example amplification process for DNA in a sample.

FIG. 4 is a flow chart illustrating a technique for LAMP-LFA amplification of DNA in a sample.

FIG. 5 is a diagram of a multistep process of using the example medical diagnostic device of FIG. 2A.

FIG. 6 is a graph of example RNA extraction efficiencies of different types of sample paper.

FIG. 7A is an illustration of results from different types of samples.

FIG. 7B is an illustration of example detection sensitivity with different quantities of target biological substance.

FIG. 8 is a flow diagram illustrating an example technique for operating a medical diagnostic device as described herein.

FIG. 9 is a conceptual diagram illustrating an example medical diagnostic device, according to the disclosure herein.

FIG. 10 is a conceptual diagram illustrating a process for modifying a surface of an electrode sensor that can be used in the device of FIG. 9.

FIGS. 11A and 11B are graphs of example detection signals for different concentrations of target DNA bonded to CRISPER-Cas9 in an electrochemical sensor.

FIG. 12 is a flow diagram illustrating an example technique for operating a medical diagnostic device of FIG. 9.

### DETAILED DESCRIPTION

In general, the disclosure describes systems, devices, and techniques for detection of diseases, such as infection diseases. Rapid and accurate detection of infectious diseases on-site, such as COVID-19, is of great importance to both treatments and pandemic management. However, in resource-limited or at-home settings, conventional medical devices face obstacles such as interrupted power supplies, a shortage of skilled professionals, sophisticated infrastructures, and high-cost. In such circumstances, clinical decisions are based on symptoms rather than diagnostic tests, leading to complex clinical complications.

In terms of the detection mechanisms, the point-of-care testing (POCT) devices can be divided into two categories: immunoassay-based methods for detection of antigens (structural surface proteins or antibodies) and nucleic acid testing (NAT) methods for direct determination of infectious pathogens (DNA/RNA, genetic materials). Presently, lateral flow assay (LFA) is a kind of user-friendly, cheap, and easily mass-produced POCT device for detection of antigens of infectious pathogens (such as COVID-19) based on immunoaffinity reaction.

LFA-based products are available. However, without any signal amplification, traditional colloidal gold based LFA is limited to relatively low sensitivity and incapable of quantification measurement. Moreover, in real clinical settings, low virus loads have been frequently observed in some patients, leading to low concentration of antigens, which ultimately leads to false-negative results when using LFA. The accuracy of LFA is declared to be about 90%.

In contrast, nucleic acid testing (NAT) methods can directly identify the specific sequences of the genetic materials of infectious and then amplify the origin concentration to a level of 10 billion˜1 trillion. With the specific identification and amplification process, the NAT methods possess a significantly higher sensitivity and specificity than LFA, with a detection accuracy up to 98%. Among the NAT methods, reverse transcription polymerase chain reaction (RT-PCR) is the considered as the gold-standard.

Although with high sensitivity and accuracy, it is typically a laboratory-based, rather than home-based detection method due to the reliance on sophisticated infrastructures and trained operators.

Unlike PCR-based methods, isothermal amplification techniques, which are conducted at fixed temperature, do not rely on the expensive instruments for thermal cycling, thus offering the convenience and potential option home-based testing. Such as loop-mediated isothermal amplification (LAMP), it is a low-cost yet rapid isothermal approach, which enables the identification of the target nucleic acid fragment of infectious pathogens within 40 min, by using a set of primers and a strand-displacement polymerase at a constant temperature (60-65° C.). Moreover, there are a lot of different ways to directly visualize a LAMP reaction product. Thus, it would be beneficial to develop integrated while affordable, sensitive, specific, user-friendly, rapid and robust, equipment-free, and deliverable (ASSURED) platforms based on isothermal amplification methods. In particular, the development of a ASSURED NAT device is a great challenge because many steps, including cell or virus lysis, nucleic acid extraction and enrichment, and nucleic acid amplification or detection signal amplification, must be accomplished in a portable while low-cost device.

As described herein, a medical diagnostic device can be used to detect biological substances, such as nucleic acids, without the disadvantages of expensive equipment or reduced detection. For example, an example medical diagnostic device described herein can be ultra-sensitive, accurate, low-cost, easy-to-use, and a fast platform for diagnostics of SARS-CoV-2 antigen. In some examples, the diagnostic device have one or more of the following attributes: 1) embedded loop-mediated Isothermal amplification (LAMP), 2) integrated RNA extraction and lateral flow immunoassay with LAMP, 3) sample-in-answer-out (RNA extraction +isothermal amplification), 4) high sensitivity and accuracy (based on amplification), 5) easy operation (simple one-dimension pulling), 6) visual reading (results can be read directly by naked eyes), and/or 7) low cost (polymer and paper hybrid construction).

Rapid and accurate detection of infectious diseases on-site can enable timely isolation of infected cases and effective contact tracing of potential infected cases. This can provide both treatments and pandemic management. The medical diagnostic device described herein can be manufactured with a low cost, have easy operation, and high sensitivity and specificity for point-of-care detection of infectious diseases at-home or in remote areas. The device can be ultraportable: such as less than 100 grams in weight and smaller than 10 cm in length, less than 3 cm in height, and less than 3 cm in width in some examples. The device can then be a completely novel structure is designed and adopted to integrate full functions, including sample preparation, nucleic acid amplification, and final readouts in a single medical diagnostic device. The device can enable the entire detection process through simple stretching outwards along one direction with the fingers of a single user. The detection results can be read directly by naked eye. The device can also be of low-cost and easily affordable for home-based testing or remote-area testing. The low cost of the device can facilitate disposable attributes such that a new device can be used for each sample instead of sterilizing the same device for testing different samples. In some examples, the device can include three low-cost plastic layers (including but not limited to PMMA, polycarbonate, or any other polymer or composite) fabricated by laser-cutting. The device can eliminate the needs for any additional instruments when testing, further reducing the costs. The device can be versatile for testing different biological substances while highly sensitive and accurate.

As a detection platform, it can be integrated with different kinds of isothermal amplification methods (including but not limited to LAMP, recombinase polymerase amplification (RPA), with a limit of detection (LOD) up to 1,000 copies/mL and a detection accuracy up to 98%. Compared with traditional lateral flow immunoassy (LFA), the sensitivity is 1,000 to 10,000 times higher. Moreover, the device is not only suitable for detecting COVID-19, but also suitable for different types of pathogens and viruses from a variety of sample sources (blood, urine, saliva, swabs). In some examples, the medical diagnostic device may include, in addition to, or in place of, the LFA, an electrochemical sensor configured to detect a biological substance, such as nucleic acids (e.g., DNA or RNA), within the sample. The electrochemical sensor may be coated with a chemical that selectively binds or bonds with the target substance, such as target nucleic acids associated with a disease or condition of interest. In one examples, the chemical coating the electrochemical sensor may be CRISPR-Cas9 that is configured to selectively bond to target nucleic acids.

In addition to low cost, the medical diagnostic device described herein can support portability for the entire testing process, from sample preparation to signal amplification to readouts without additional instruments. Moreover, the device enables easy-operation which realizes the entire detection process through simple stretching outwards along one direction with the user's fingers. The medical device proposed here is a kind of universal platform which is suitable for detection of different types of pathogens and viruses (such as COVID-19, Lyme diseases, Influenza, and Monkeypox) from a variety of sample sources (blood, urine, saliva, swabs).

In summary, an example medical diagnostic device described here integrates all functions from sample preparation, isothermal amplification to final readouts with a relatively low cost. The device can provide numerous advantages over other alternatives, such as ease of operation, low cost, and increases sensitivity and accuracy. For ease of operation, the device integrates full functions, including sample preparation, nucleic acid amplification and final readouts in a single chip (e.g., the device). The chip realizes the entire detection process through simple stretching outwards along one direction with the user's fingers. The results can be read directly by naked eyes instead of requiring the use of specialized equipment. With regard to cost, the device can be constructed of common polymers (such as PMMA) using commonly used manufacturing techniques such as laser-cutting. No expensive instruments are required for operation or readout. As a detection platform, it can be integrated with different kinds of isothermal amplification methods (including but not limited to LAMP, RPA), with a LOD up to 102 copies/mL and a detection accuracy up to 98%. It is suitable for detection of different kinds of biological substances found in a variety of samples including blood, saliva, urine and swabs.

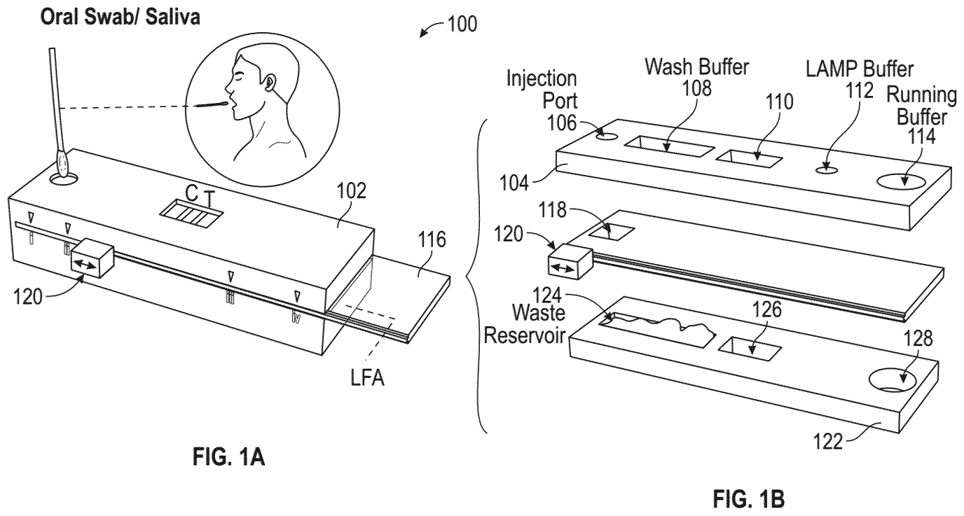

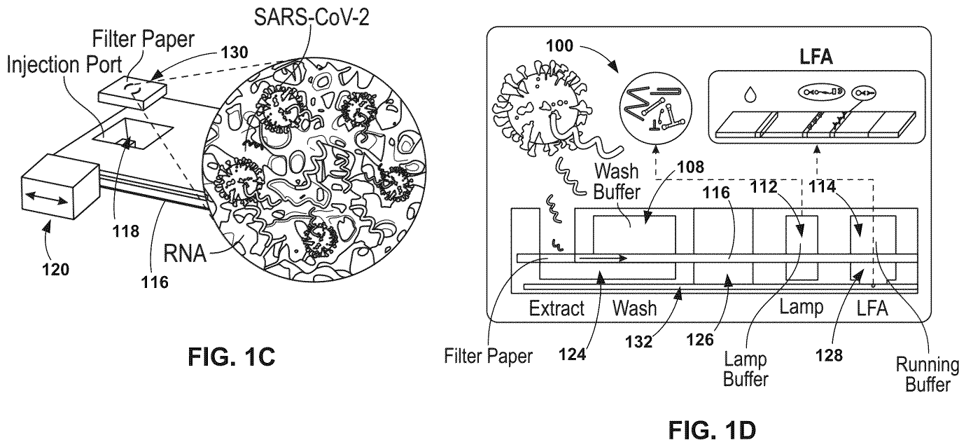

FIG. 1A is a conceptual diagram illustrating an example medical diagnostic device 100 as described herein. As shown in the example of FIG. 1A, medical diagnostic device 100 includes cover 102 that defines a window through which the sample test paper can be viewed after the diagnostic process is complete. For example, the sample test paper may include a control and test portion to confirm that the process was successful. An oral swap, for example, can be placed through an opening in cover 102 so that the sample can be placed on the test paper within medical diagnostic device 100. The end of sliding panel 116 is shown sticking out the end of cover 100, and sliding panel 116 can be moved within cover 102 via knob 120 (e.g., a handle). The entirety of medical diagnostic device 100 can be shaped like a USB disk drive or other hand-held device. In some examples, medical diagnostic device 100 has a length less than about 10 cm, a width less than about 3 cm, and a height less than about 3 cm.

FIG. 1B is an exploded view of the example medical diagnostic device of FIG.

1A. As shown in the example of FIG. 1B, medical diagnostic device 100 includes three layers, such as first housing portion 104, sliding panel 116, and second housing portion 122. First housing portion 104 may be referred to as a top layer, sliding panel 116 may be referred to as a middle layer, and second housing portion 122 may be referred to as bottom layer 122. In some examples, the three layers may be constructed of PMMA and fabricated by laser-cutting, which is rather low-cost. The three layers are tightly integrated together. In some examples, one or more seals may be provided between the layers to prevent liquid from moving between the layers and migrating between different chambers.

First housing portion 104 may have a thickness of 4 mm in some examples. First housing portion 104 may define injection port 106 through which the sample can be placed. First housing portion 104 may also define one or more additional chambers that may include respective fluids, such as chamber 108, chamber 110, chamber 112, and chamber 114. One or more of these chambers may be pre-packaged with a specific fluid.

In one example, chamber 108 may hold a washing buffer, chamber 112 may hold a

LAMP buffer, and chamber 114 may hold a strip running buffer. Chamber 110 may hold another buffer or be left empty and used as a viewing window for the results of the test paper.

Sliding panel 116 may define knob 120 and sample chamber 118. In some examples, sliding panel 116 may have a thickness of about 3 mm. Sliding panel 116 may be used to load an FTA card (3*3 mm) to lyse the virus and then absorb nucleic acid of the sample. Sample chamber 118 may be configured to hold the FTA card or another test paper or sample paper that holds the sample and enables viewing of the results of the test. Liquid may pass through the paper and through sample chamber 118.

Second housing portion 122 may have a thickness of about 4 mm thick in some examples. Second housing portion 112 may define waste reservoir 124 which may have one or more chambers and/or a continuous chamber with apertures corresponding to the respective chambers of first housing portion 104. For example, a hole may correspond to the sample pad of the LFA below. Other waste chambers may include chamber 126 and 128.

LFA is used for the detection of isothermal amplicons, whose results can be read directly by naked eyes. Based on isothermal amplifications, the concentration of target nucleic acids can be amplified to a level of 106 to 1010 within 25˜45 min. Isothermal amplification may be provided via an internal heating element (not shown) or external heat sources such as a heating pad or warm water bath. Compared to an individual LFA that directly detects antigens, the sensitivity of the device can be 103 to 104 times higher. A result-reading window 110 is designed on the middle of the device at the corresponding detection line and control line of the LFA for easy reading.

Once the amplification amplicons are loaded with running buffer into the sample pad of the LFA, the final results can be read directly from the chamber or window 110. In this manner, medical diagnostic device 100 can be preloaded with all solutions or reagents needed for the diagnostic process. The user can manually add the sample into the injection port 106 to the sample paper and move the sample through the different chambers of medical diagnostic device 100 until the results are available. As shown in FIG. 1A, case 102 may include markings on the outside of the device that show each position to move sliding panel 116 during the diagnostic process. When time is important at each stage, the user may follow a timer or follow instructions via a software application operating on a computing device, such as a smartphone or handheld computer.

In this manner, medical diagnostic device 100 may be a diagnostic system that includes a first housing portion defining an injection port, a first chamber configured to contain a first solution, a second chamber configured to contain a second solution, a second housing portion defining at least one waste chamber configured to receive fluid from at least one of the first chamber or the second chamber. The device may also include a sliding panel comprising a sample chamber configured to contain a biological sample, wherein the sliding panel is positioned between the first housing portion and the second housing portion and configured to move the sample chamber to different positions corresponding to at least the first chamber and the second chamber of the first housing portion. Cover 102 may enclose at least a portion of the first housing portion, the sliding panel, and the second housing portion.

In some examples, at least a first fluid seal is provided between the first housing portion and the sliding panel and at least a second fluid seal between the second housing portion and the sliding panel. The waste chamber, or reservoir, may be a single chamber or include separate respective chambers for each of the first chamber and the second chamber. Waste reservoir 124, alone or in combination with other chambers such as chambers 126 and 128, may accept excess fluid that falls from the respective chamber in first housing portion 104 when sample chamber 118 is moved between a chamber containing the fluid or solution and the below waste reservoir. In this manner, the solution is applied to the test paper and excess solution passes through to the waste reservoir.

First housing portion 104 may include viewing window 110 extending fully through first housing portion 104, wherein the sample associated with sliding panel 116 is exposed via viewing window 110 and the window in cover 102. The sample chamber 118 may include filter paper.

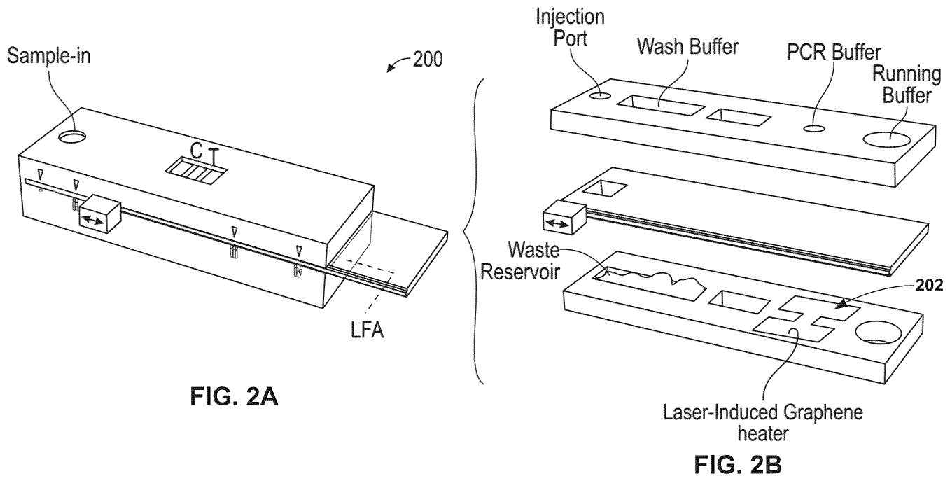

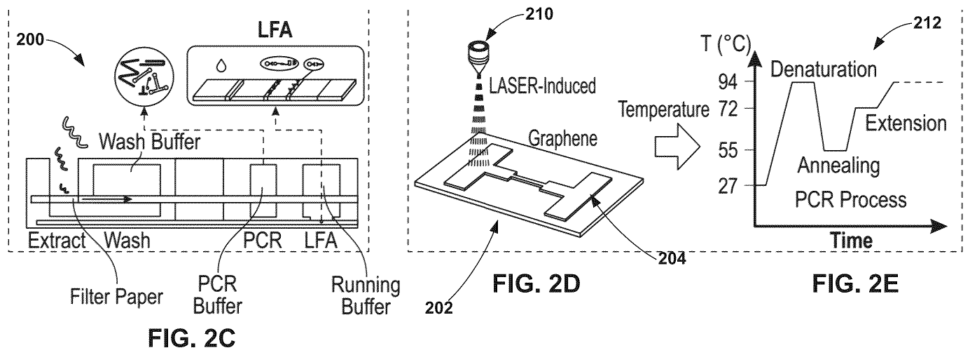

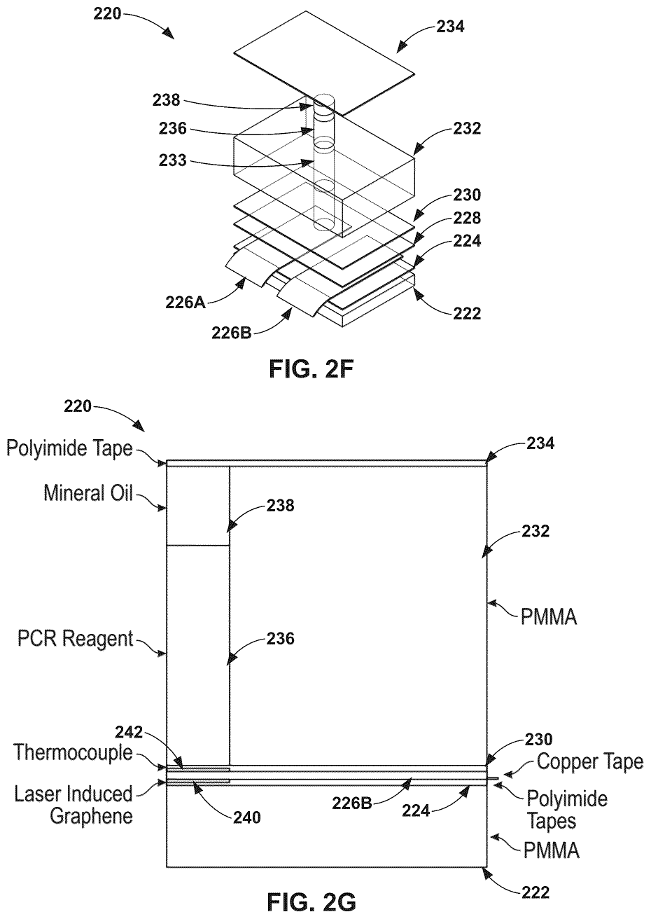

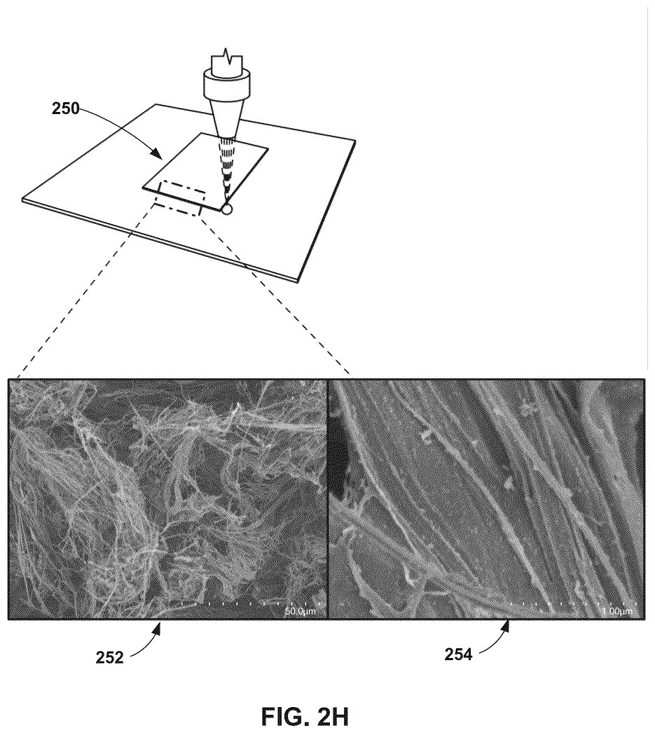

As described herein, medical diagnostic device 100 may include a heating element carried on second housing portion 122. In some examples, the heating element comprises a graphene heating element as shown in FIG. 2B. However, other sources of heat may be contemplated, such as resistive metal heating elements, warm water baths, etc.

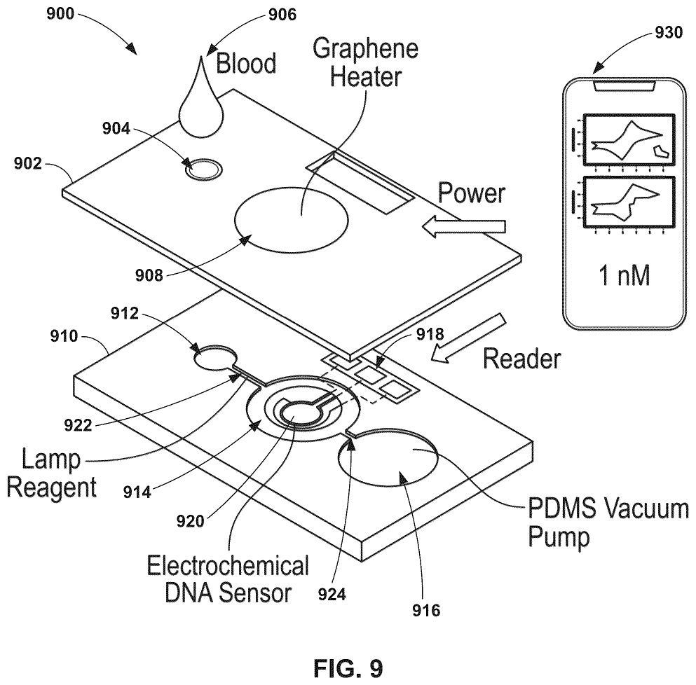

FIG. 1C is a conceptual view of a sample applied to filter paper 130 that would be placed within injection port 106 of medical diagnostic device 100. As shown in the example of FIG. 1C, filter paper 130 can be held within the sample chamber 118 of sliding plane 116. The sample may contain RNA from SARS-CoV-2 infected patients, as may be detected by medical diagnostic device 100, or another device such as medical diagnostic device 900 of FIG. 9.

FIG. 1D is a cross-sectional view of the example medical diagnostic device 100 of FIG. 1A. In some examples, the DNA washing buffer (2*700 μL) in chamber 108, isothermal amplification reaction buffer (20 μL) in chamber 112, and running buffer (200 μL) in chamber 114 are pre-packaged into the corresponding liquid storage chambers (108, 112, and 114). As a result, potential liquid leakage is a concern. To prevent liquid leakage, 1H,1H,2H,2H-Perfluorooctyl Trichlorosilane, a kind of hydrophobic material, can be used for hydrophobic treatment of each layer of the chip (e.g., medical diagnostic device 100). Moreover, the viewing window 110 (in FIG. 1B) can be tightly sealed with one or more adhesive films. The waste reservoir 124 can be filled with cotton or other absorbing material to absorb the waste liquid. The entire chip of medical diagnostic device 100 can thus be manufactured in a sealed state, which can effectively prevent liquid leakage and aerosol pollution during detection. The DNA wash buffer used can be 10 mM Tris (pH=8). Isothermal amplification buffer can contain the primers and reaction mixture provided from the Loopamp® DNA Amplification kit. Running buffer is Tris-EDTA buffer.

FIG. 2A is a conceptual diagram illustrating an example medical diagnostic device 200 as described herein. Medical diagnostic device 200 may be substantially similar to medical diagnostic device 100 of FIG. 1A. However, medical diagnostic device 200 may include one or more heating elements, such as heating element 202 (shown in FIG. 2B) within medical diagnostic device 200 that is configured to heat the sample and provide thermal amplification of the biological substance, such as nucleic acids.

FIG. 2B is an exploded view of the example medical diagnostic device 200 of FIG. 2A. As shown in FIG. 2B, medical diagnostic device 200 includes chambers configured to hold solutions such as a wash buffer, PCR buffer, and running buffer in the upper layer or first housing portion. In the lower layer or second housing portion 122, a waste reservoir is provided in addition to a heating element 202. An example heating element may be a laser-induced graphene heater. In some examples, heating element 202 is shaped like an “H”, but other shapes are also contemplated, such as circles, ovals, triangles, squares, polygons, or other curved or amorphous shapes. In some examples, the shape of heating element 202 may correspond to the shape of sample chamber 118 to focus heating. Heating element 202 may be smaller than sample chamber 118 to focus heating to a certain location or larger than sample chamber 118.

The graphene heater (which may include heating element 202) may be powered by an internal power source (e.g., a battery) or an external power source (e.g., an AC output or via connection to another battery power source that could include a mobile computing device). The internal or external power source may include circuitry configured to control the power delivered to heating element 202 to achieve desired temperatures needed to complete amplification. Temperatures of heating element 202 may be indirectly estimated based on delivered current to heating element 202 or directly controlled via one or more temperature sensors that provide feedback to control the temperature of heating element 202.

In one example, during detection, 20 μL of raw sample (saliva/swabs/urine/blood) is directly added into the medical diagnostic device 200 via the injection port to reach the surface of FTA paper contained by the sample chamber of the sliding place. The FTA paper can be configured to provide solid-phase extraction function as it is a special filter paper soaked by strong denatured agent and chelating agent. In this manner, the virus will be lysed and the corresponding nucleic acids will be adsorbed onto the FTA paper. In the second step, the user can grab the knob of the sliding plane to slide the FTA card to the washing chambers to remove impurities and inhibitors on the surface of the FTA card.

In the third step, the user can again pull the knob of the sliding plane to slide the FTA paper into the isothermal amplification chamber associated with the heating element, where the isothermal amplification reactions are completed by medical diagnostic device 200. In some examples, the reaction could be carried out under a constant temperature (e.g., 35˜42° C. for RPA or 60˜65° C. for LAMP). The temperature can be achieved by low-cost laser-induced graphene heater (e.g., example heating element 202) through wired or wireless communications with a mobile computing device (e.g., a tablet computer or smartphone). In the final step, the user can again pull on the knob of the sliding plane to slide the FTA paper with the amplification products out to the chamber storing the running buffer. Along with the amplification products, the running buffer flows to the sample pad of the LFA, and a color reaction will be presented on the test line and control line of the FTA paper. The amplification results can be observed through the viewing window of medical diagnostic device 200 by naked eye of the user. After results are shown, medical diagnostic device 200 could be disposed of because it may be configured to be a single-user device for only a single sample.

FIG. 2C is a cross-sectional view of the example medical diagnostic device 200 of FIG. 2A. FIG. 2D is a conceptual diagram of a laser-induced generation of a graphene heating element 202 that can be placed within medical diagnostic device 200. The laser-induced manufacturing process may include laser 210 that generates a graphene element 204 that can be heated with relatively small electrical current and increase and decrease temperatures relatively quickly as needed for the amplification process. The shape of the graphene element 204 (which is part of heating element 202) may be selected as needed for target temperatures and/or to improve heating and cooling times for each cycle.

FIG. 2E is a graph 212 of an example PCR process executed by the example medical diagnostic device 200 of FIG. 2A. As shown in FIG. 2E, heating element 202 may be controlled to increase and decrease temperatures at specific times in order to achieve different phases of the amplification process. This may include heating for denaturation, cooling for an annealing process, and then again heating for extension. Such a process may be repeated as needed.

FIGS. 2F and 2G are an exploded view and cross-sectional view of an example graphene heating device 220 and example chamber to be heated. Graphene heating element 220 may be similar to a portion of medical diagnostic device 200 and/or heating element 202. As shown in the examples of FIGS. 2F and 2G, the layers and components of a laser induced graphene heating element 220 and corresponding heating structure can be fabricated quickly, such as less than 10 minutes or less than 3 minutes, with relatively simple assembly. In one example, all components of a laser induced graphene heating device can be assembled together by polyimide tape 224 and the majority of the components can be laser cut. In the example of FIG. 2F, the layers, from bottom to top, include PMMA layer 222, polyimide tape 224 (which can include graphene layer 240), copper tape 226A and 226B, polyimide tape 230, PMMA layer 232, and polyimide tape 234. PMMA layer 232 defines chamber 233 that is configured to retain substances, such as PCR reagent 236 and mineral oil 238. The heating element is not shown in FIG. 2E.

FIG. 2G illustrates an example cross section of the layers and components of a laser induced graphene heating device 220. The base may be constructed of a layer of PMMA 222 with a layer of polyimide tape 224 on the PMMA layer 222. A CO2 laser may write on at least a portion, e.g., some of, or all of, the polyimide tape 224 to generate a laser induced graphene layer 240. One or more electrically conductive layers, such as a copper tape 226B, may be placed on top of and in contact with the laser induced graphene layer 240. A thermocouple 242 may be placed on top of the copper tape 226B, but may be placed in other locations of the device in other examples. Another layer of polyimide tape 230 may be placed over the copper tape 226B. A main PMMA layer 232 may be placed on top of the polyimide tape 230. The main PMMA layer 232 may create chambers (e.g., chamber 233 in FIG. 2G) that may be constructed to hold a fluid or other substance to the heated, such as a chamber for a PCR reagent 236 and/or a mineral oil layer 238 that may reduce evaporation of the PCR reagent 236. A layer of polyimide tape 234 may provide a final top layer to the device 220. This construction is just one example for a laser induced graphene heating device. Greater or fewer layers, and/or other materials, may be used in different examples.

FIG. 2H includes different magnification images of a laser induced graphene layer 250 (which may be similar to graphene layer 240 of FIG. 2G) for a heating element, such as heating element 202. A laser induced graphene heating element can be generated by laser rastering using a 10.6 micrometer CO2 laser. Other CO2 lasers may be used in other examples. As shown in the left image 252 with the scale of 50 micrometers, the cross-section of the laser induced graphene element resembles a forest morphology. In some examples, the thickness of the laser induced graphene layer 250 may be less than 1 millimeter. In other examples, the thickness of the laser induced graphene layer may be less than 500 micrometers, or less than 300 micrometers. Individual filaments may be less than 100 nanometers, less than 50 nanometers, or even less than 30 nanometers. Image 254 shows a magnified view of a filament of graphene layer 250, with a scale of 1 micrometer.

One of the differences between a laser induced graphene layer 250 and spin coated graphene ink is the structure of the graphene. As opposed to the forest morphology of the laser induced graphene layer, cured graphene ink forms multilayer sheets that are generally parallel with the plane of the graphene layer. The forest morphology of the laser induced graphene layer can provide improved heating performance compared to graphene ink, such as more efficient heat generation from the same power input (e.g., increased heating with less electrical power) and increased heating and cooling rates.

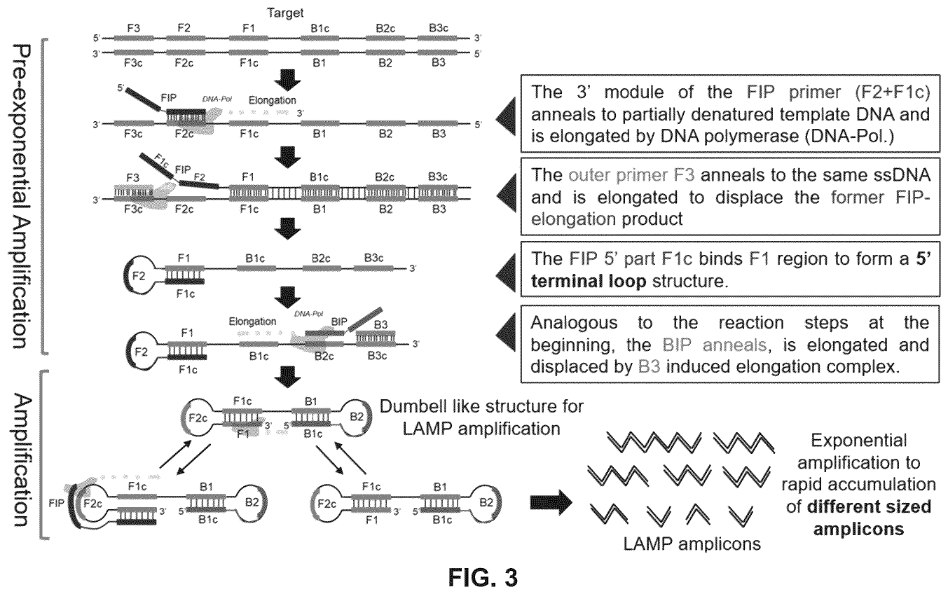

FIG. 3 is a diagram of an example working principle of LAP. In the example loop-mediated isothermal amplification of FIG. 3, the process includes a pre-exponential amplification process in which an FIP primer is annealed to a partially denatured template DNA. Then, further amplification occurs for rapid accumulation of different sized amplicons.

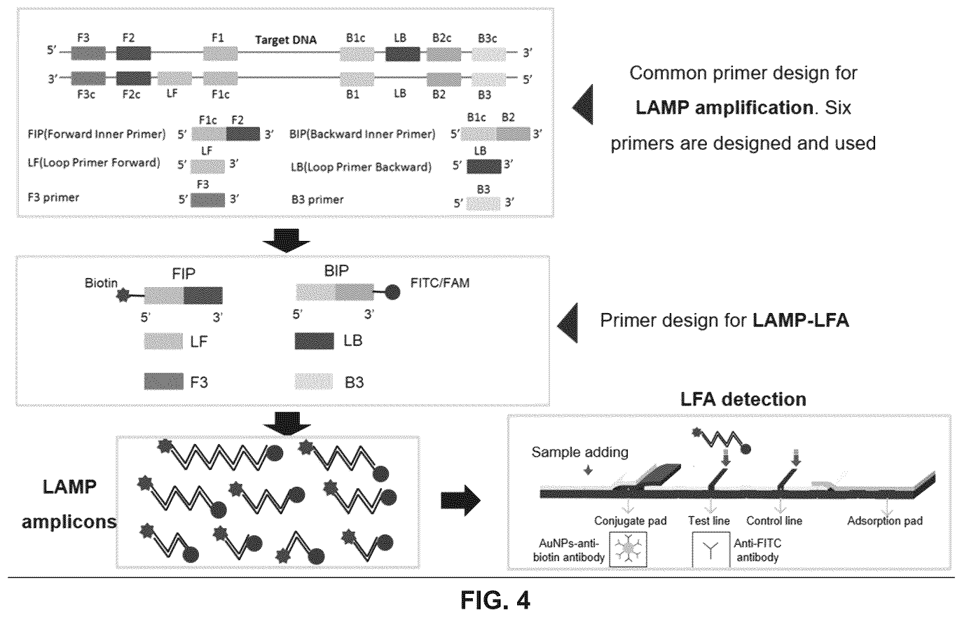

FIG. 4 is a flow chart illustrating a technique for LAMP-LFA amplification of DNA in a sample. In some examples, the designed primers can specifically identify the target sequence and then amplify with the aid of enzymes. The primers can have a significant impact on the sensitivity and specificity of the assay. To obtain better performance, several sets of primers can be designed targeting at the infectious pathogens. All primers can be examined by NCBI BLAST to confirm cross-reactivity before synthesis. Different sets of primers can be tested to investigate corresponding properties. The primers with best sensitivity and specificity can be used for any medical diagnostic devices described herein.

To visualize the isothermal application products, LFA is used. The Loop F/B primers are modified with Biotion and FITC respectively. After amplification, the target gene will form products carrying biotin and FITC. When the amplification product is dropped onto the LFA with the running buffer, the FITC modified on the product would bind to the gold-labeled anti-FITC antibody, and the biotin would be captured by streptavidin on the detection line of the strip, thus rendering color reaction. And the excess colloidal gold continues to flow to the control line, which combined with the secondary antibody to develop color reaction.

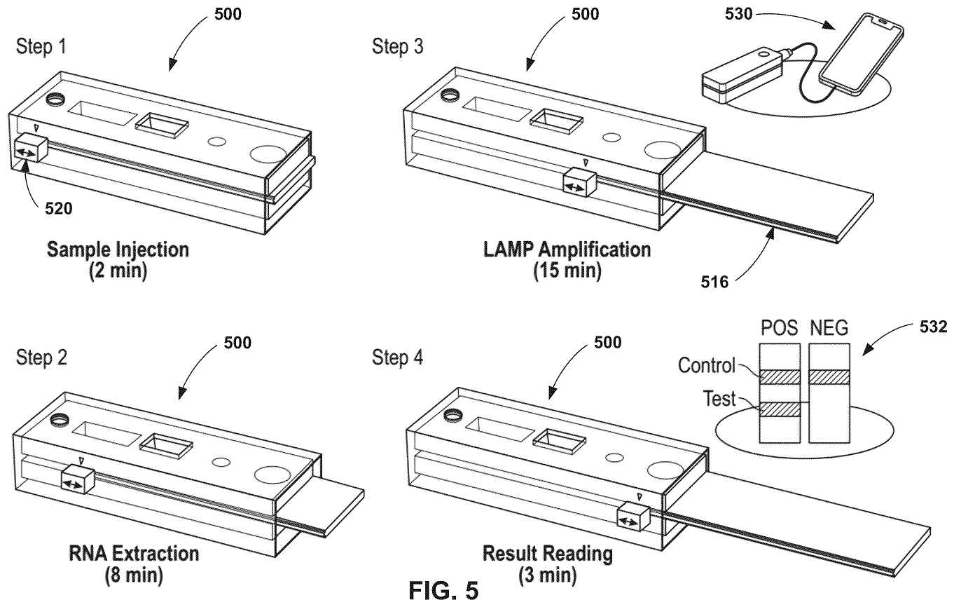

FIG. 5 is a diagram of a multistep process of using the example medical diagnostic device 500 of FIG. 2A. Medical diagnostic device 500 may be similar to medical diagnostic devices 100 or 200. The steps of FIG. 5 may be completed using a heating element (such as heating element 202) that draws power from a mobile device 530, for example. In step 1, the sliding plane 516 is positioned using knob 520 to receive the sample through the injection port. In step 2, the user slides the sliding plane 516 using knob 520 to the first chamber where the washing buffer is added to the sample and extract RNA from the sample. In step 3, the user moves the sliding plane 516 so that the sample chamber is positioned over the LAMP chamber and heating element. In this position, the device may undergo isothermal amplification, for example. Once this amplification step is complete, the user can, in the next step 4, move the sliding plane to the running buffer chamber as the final step to prepare the sample on the filter paper for viewing. In one example, the viewing window may be at this step four such that the filter paper 532 can be visible to the user. In other examples, the viewing window may be in the middle of the case such that the user can move the sliding panel back until the sample chamber and filter paper 532 therein can be visible through the viewing window at that location. In some examples, the filter paper 532 will include a control and test portion of the filter paper. The control color change indicates that the process was successful, and the test color change would only occur if the sample is positive for the biological substance between tested for, such as COVID-19.

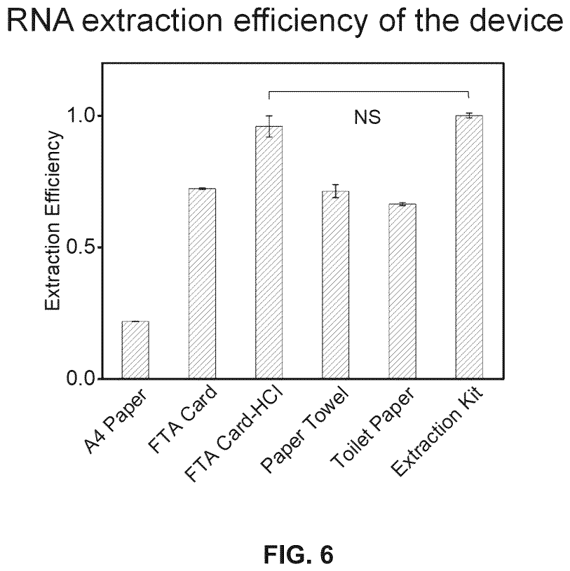

FIG. 6 is a graph of example RNA extraction efficiencies of different types of sample paper. As shown in the example of FIG. 6, the RNA extraction efficiency with the device described herein using an FTA card with hydrochloric acid (HCl) is similar to a full extraction kit. Lesser efficient mediums include A4 paper, paper towel, toilet paper, and an FTA card without HCl.

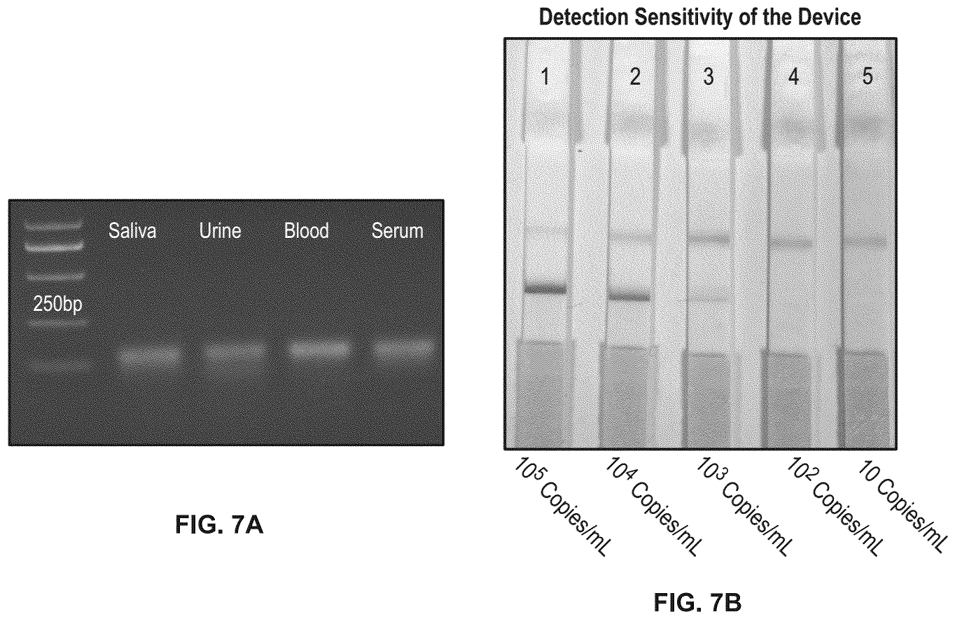

FIG. 7A is an illustration of results from different types of samples. As shown in the example of FIG. 7A, target DNA from all different sample types of saliva, urine, blood, and serum can be extracted and amplified in a medical diagnostic device described herein, as identified in an electrophoresis gel run.

FIG. 7B is an illustration of example detection sensitivity with different quantities of target biological substance. As shown in the example of FIG. 7B, a medical diagnostic device as described herein may have a sensitivity of at least 10\hat{ }3 copies per mL. Detection sensitivity may be different for different target DNA, different amplification techniques, reagent quality, etc.

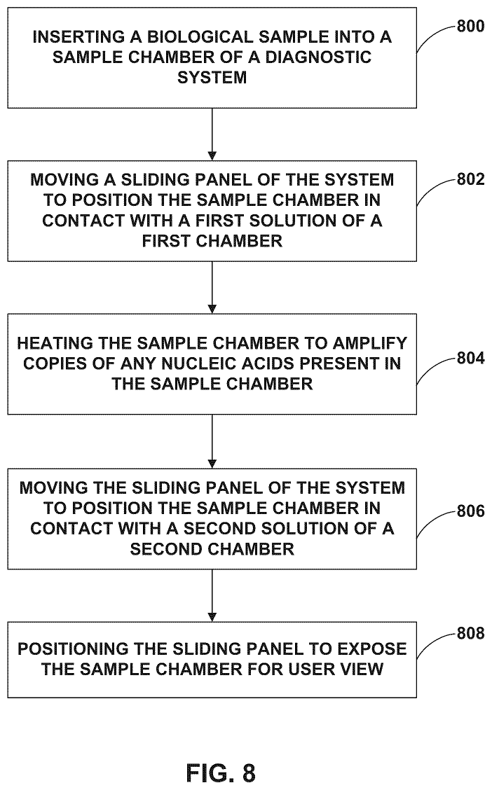

FIG. 8 is a flow diagram illustrating an example technique for operating a diagnostic system for analyzing a biological sample. The example of FIG. 8 is described with respect to medical diagnostic device 200, but may be executed by other systems or devices described herein, such as medical diagnostic device 100, 500, or 900 (of FIG. 9).

As shown in the example of FIG. 8, a user may insert a biological sample into a sample chamber of a diagnostic system, such as medical diagnostic device 200 (800). The sample chamber may be within a sliding panel, and the sample chamber may include filter paper to retain the sample provided by the user. Medical diagnostic device 200 may be pre-filled with appropriate solutions in each chamber of the device configured to detect the presence of a target biological substance, such as RNA from a virus.

The user can them move a sliding panel of medical diagnostic device 200 to position the sample chamber in contact with a first solution of a first chamber (802). For example the first solution may be a wash buffer that flows over the sample, or a PCR buffer if the wash buffer or equivalent has already been applied to the sample. The user can then initiate heating of the sample chamber to amplify copies of any nucleic acids present in the sample chamber (804). The heating may be performed using an external heat source such as a water bath, heating pad, or other heating product. In some examples, the heating will be provided by a heating element 202, for example, that may be carried within medical diagnostic device 200. A graphene heater as described herein is one example of heating element 202.

After the heating process is complete, the user can move the sliding panel of medical diagnostic device 200 to position the sample chamber in contact with a second solution in a second chamber (806). This second solution may be a running buffer or any other solution that is needed to be applied to the products of the amplification step. The user can then position the sliding panel to expose the sample chamber, and filter paper positioned therein, to be viewed through a viewing window of medical diagnostic device 200 (808).

FIG. 9 is a conceptual diagram illustrating an example medical diagnostic device 900. Medical diagnostic device 900 may be similar to medical diagnostic devices 100, 200, and 500. However, medical diagnostic device 900 includes electrochemical sensor 920 that can generate a detection signal indicative of a biological substance within a biological sample provided (e.g., blood sample 906 or another bodily fluid or tissue). In this manner, medical diagnostic device 900 can provide an alternative approach for DNA detection than using a Lateral Flow Assay (LFA) as described with respect to medical diagnostic device 100. In some examples, a medical diagnostic device may include electrochemical sensor 920 (and additional components of medical diagnostic device 900) and the components for the LFA of device 100. In some examples, electrochemical sensor 920 may be configured to perform electrochemical sensing based on CRISPR-Cas9 modification of at least one electrode surface of electrochemical sensor 920.

Example medical diagnostic device 900 includes first housing portion 902 that defines injection port 904 (e.g., an opening) that receives sample 906 and includes heating element 908 (e.g., a graphene heating element). First housing portion 902 may be placed on top of, and in contact with, second housing portion 910. In some examples, first housing portion 902 may be sealed to second housing portion 910 using an adhesive, fasteners, or other such coupling mechanisms. In some examples, one or more seals may be disposed around various chambers and between first housing portion 902 and second housing portion 910 to seal any fluid within medical diagnostic device 900. Second housing portion 910 defines sample chamber 912, channel 922, reaction chamber 914, electrochemical sensor 920, vacuum pump 916, channel 924 between reaction chamber 920 and vacuum pump 916, and sensor reader 918.

Heating element 908 may be powered to increase temperature on demand to increase, or decrease, the temperature of any fluid within reaction chamber 914. Electrochemical sensor 920 may be configured to detect a target substance within sample 906. In some examples, medical diagnostic device 900 can perform electrochemical sensing for DNA or other biological substance. After sample 906 is received into sample chamber 912 via injection port 904, vacuum pump 916 (e.g., a pre-compressed PDMS vacuum pump or actuated pump) can be released to aspirate the solution containing sample 906 and, in some example, amplified DNA, from sample chamber 912, through channel 922, into reaction chamber 914 equipped with electrochemical sensor 920. In some examples, LAMP reagent may be predisposed in channel 922 and/or disposed within sample chamber 912 to mix with biological substances within sample 906.

Electrochemical sensor, can, in some examples, include a three-electrode system configured to measure electrochemical signals with a portable potentiostat. In some examples, the sensing process may include voltammetry or other technique in which the current and/or voltage between electrodes changes based on the substance contacting and/or in solution between, the electrodes. Reader 918 can then transmit the detection signal generated by electrochemical sensor 920 to another device, such as a wireless communication device (e.g., mobile computing device 930), a wired device, or any other communication and/or display device. When used as a standalone DNA detection device, heating element 908 (e.g., a laser-induced graphene heater) located on first housing portion 902 at the top of the reaction chamber 914 can be powered by mobile computing device 930 via wired or wireless means to complete the LAMP amplification process inside reaction chamber 914.

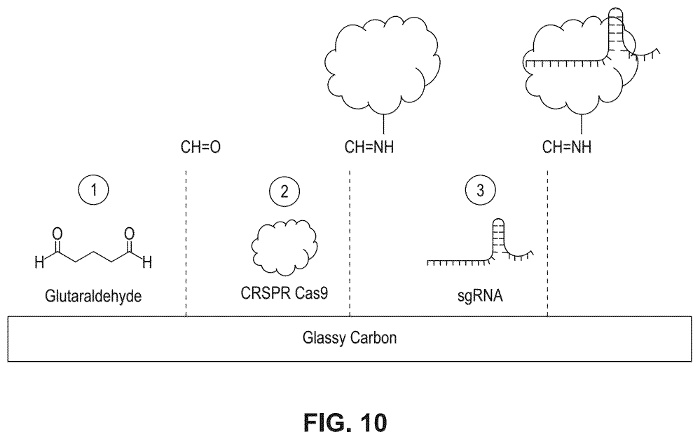

FIG. 10 is a conceptual diagram illustrating a process for modifying a surface of an electrode sensor that can be used in the device of FIG. 9. In some examples, the electrode surface of electrochemical sensor 920 can be coated with CRISPR-Cas9 for specific bonding with target DNA to achieve selective detection. The electrode may be constructed of carbon, such as glassy carbon in some examples. The example coating process may include initially immersing the electrodes for a time (e.g., 20 minutes, or less or more in other examples) in a solution containing the target DNA. Subsequently, 10 mM Hexaammineruthenium(III) chloride (RuHex) is dropped onto the electrode surface, which is then followed by an incubation period, which may be approximately 5 minutes in some examples. Later, the process of detection of the target DNA in a sample may include detecting the oxidation peak of RuHex in a Tris-EDTA buffer using Differential Pulse Voltammetry (DPV) via the electrodes of the electrochemical sensor. DPV may be a process during which electrical voltage is increased and/or decreased to the sample and the resulting electrical current is monitored for a response indicative of a target substance, such as a target DNA.

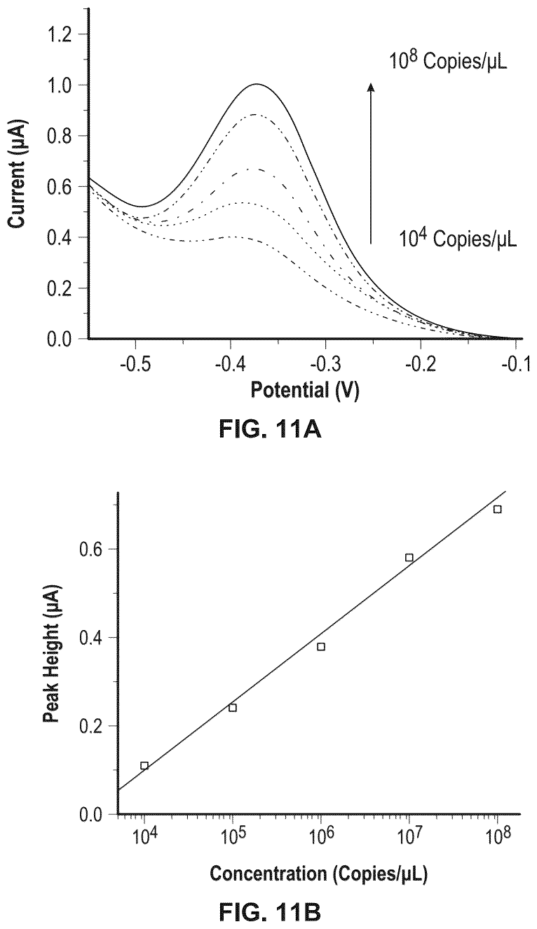

FIGS. 11A and 11B are graphs of example detection signals for different concentrations of target DNA bonded to CRISPER-Cas9 in an electrochemical sensor. In the example of FIGS. 11A and 11B, test results of different DNA concentrations (FIG. 11A) and the calibration curve (FIG. 11B) for electrochemical sensing based on CRISPR Cas9 are shown for one example.

FIGS. 11A and 11B are just one example of the response and calibration curves of the CRISPR-Cas9 coated electrochemical sensor at different concentrations of target DNA. As the target DNA concentration increases, more target DNA is captured on the electrode surface by CRISPR-Cas9. Since RuHex can bind with double-stranded DNA, more RuHex is attached to the electrode surface, resulting in a higher oxidation peak during the DPV process. The calibration curve of FIG. 11B demonstrates linearity in the relationship between the peak height of current and the concentration of the target DNA. The lowest concentration tested was 10,000 copies/μL, equivalent to 16 pM of target DNA. This is just one example, any other response and calibration curves may be representative of different target DNA.

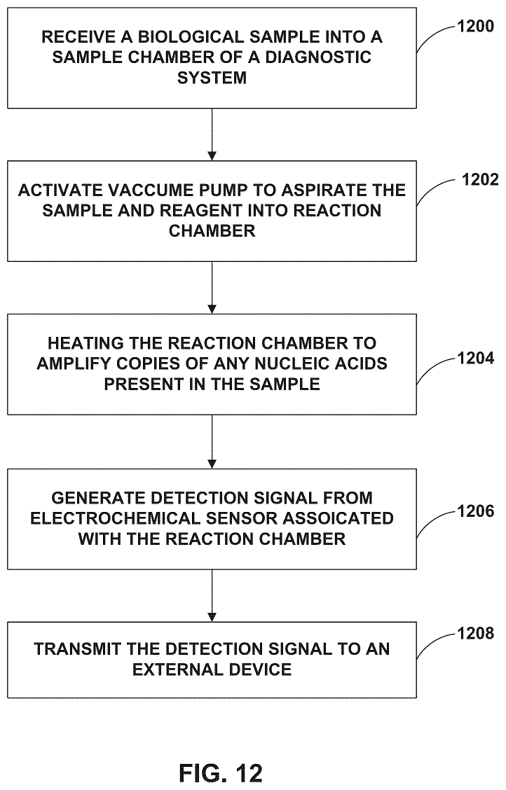

FIG. 12 is a flow diagram illustrating an example technique for operating a medical diagnostic device of FIG. 9. The example of FIG. 8 is described with respect to medical diagnostic device 900, but may be executed by other systems or devices described herein, such as medical diagnostic devices 100, 200, or 500.

As shown in the example of FIG. 12, medical diagnostic device 900 may receive a biological sample into a sample chamber 912 (1200). The sample chamber 912 may be within second housing portion 910, and sample chamber 912 may include one or more filters or fluids for initial treatment of the sample. In this manner, medical diagnostic device 900 may be pre-filled with appropriate solutions in each chamber of the device configured to detect the presence of a target biological substance, such as DNA from a virus.

The user (or device 900) can then activate vacuum pump 916 to aspirate the sample and reagent through channel 922 and into reaction chamber 920 (1202). Medical diagnostic device 900 can then initiate heating of reaction chamber 920 to amplify copies of any nucleic acids present in reaction chamber 920 (1204). The heating may be performed using an external heat source such as a water bath, heating pad, or other heating product. In some examples, the heating will be provided by heating element 908 carried by medical diagnostic device 900. A graphene heater as described herein is one example.

After the heating process is complete, medical diagnostic device 900 can activate biochemical sensor 920 that is associated with reaction chamber 914 to generate a detection signal that is representative of the concentration of target substance within reaction chamber 914 (1206). Medical diagnostic device 900 can then transmit the detection signal to an external device, such as mobile computing device 930 for further processing and/or display to a user (1208). In some examples, mobile computing device 930 may wireless connected to medical diagnostic device 900, or mobile computing device 930 may be wired to medical diagnostic device 900 to receive the detection signal and/or power medical diagnostic device 900.

The following examples are described herein:

Example 1. A diagnostic system, the system comprising: a first housing portion defining: an injection port; a first chamber configured to contain a first solution; and a second chamber configured to contain a second solution; a second housing portion defining at least one waste chamber configured to receive fluid from at least one of the first chamber or the second chamber; and a sliding panel comprising a sample chamber configured to contain a biological sample, wherein the sliding panel is: positioned between the first housing portion and the second housing portion; and configured to move the sample chamber to different positions corresponding to at least the first chamber and the second chamber of the first housing portion.

Example 2. The system of example 1, further comprising a cover configured to enclose at least a portion of the first housing portion, the sliding panel, and the second housing portion.

Example 3. The system of any of examples 1 and 2, further comprising at least a first fluid seal between the first housing portion and the sliding panel, and at least a second fluid seal between the second housing portion and the sliding panel.

Example 4. The system of any of examples 1 through 3, wherein the at least one waste chamber comprises separate respective chambers for each of the first chamber and the second chamber.

Example 5. The system of any of examples 1 through 4, wherein the first housing portion defines a viewing window extending fully through the first housing portion, wherein the sample associated with the sliding panel is exposed via the viewing window.

Example 6. The system of any of examples 1 through 5, wherein the sample chamber comprises filter paper.

Example 7. The system of any of examples 1 through 6, wherein the sliding panel comprises a handle configured to be grasped by a user, and wherein the handle is configured to move the sliding panel in response to movement of the handle by the user.

Example 8. The system of any of examples 1 through 7, further comprising a heating element carried on the second housing portion.

Example 9. The system of example 8, wherein the heating element comprises a graphene heating element.

Example 10. The system of any of examples 1 through 9, further comprising a third chamber configured to contain a third solution, wherein the waste chamber is configured to also receive fluid from the third chamber.

Example 11. The system of example 10, wherein the first solution comprises a wash buffer, the second solution comprises a LAMP buffer, and the third chamber comprises a running buffer.

Example 12. The system of any of examples 1 through 11, wherein the system is configured to accept the biological sample to the sample chamber and complete a diagnostic indication of a presence of a biological substance within the biological sample.

Example 13. The system of any of examples 1 through 12, further comprising an electrochemical sensor associated with the sample chamber, wherein the electrochemical sensor is configured to generate a detection signal indicative of a concentration of a biological substance of the biological sample.

Example 14. A method comprising: inserting a biological sample into a sample chamber of a diagnostic system, wherein the diagnostic system comprises: a first housing portion defining: an injection port; a first chamber configured to contain a first solution;

and a second chamber configured to contain a second solution; a second housing portion defining at least one waste chamber configured to receive fluid from at least one of the first chamber or the second chamber; and a sliding panel comprising the sample chamber configured to contain the biological sample, wherein the sliding panel is positioned between the first housing portion and the second housing portion and configured to move the sample chamber to different positions corresponding to at least the first chamber and the second chamber of the first housing portion; moving the sliding panel such that the sample chamber comes in contact with the first solution of the first chamber; moving the sliding panel such that the sample chamber comes in contact with the second solution of the second chamber; and positioning the sliding panel to expose the sample chamber for user viewing of a diagnostic result indicated by the sample chamber.

Example 15. The method of example 14, further comprising heating the sample chamber at a position corresponding to the first chamber.

Example 16. The method of any of examples 14 or 15, wherein inserting the biological sample comprises applying the biological sample to filter paper retained within the sample chamber.

Example 17. The method of any of examples 14 through 16, wherein the diagnostic system is configured to perform a polymerase chain reaction (PCR) process on the biological sample.

Example 18. The method of any of examples 14 through 17, wherein the diagnostic system is configured to determine whether or not the biological sample is positive for COVID-19.

Example 19. The method of any of examples 14 through 18, further comprising generating, by an electrochemical sensor associated with the sample chamber, a detection signal indicative of a concentration of a biological substance of the biological sample.

Example 20. A diagnostic device comprising: a first housing portion defining: an injection port configured to accept a biological sample; a first chamber configured to contain a wash buffer; and a second chamber configured to contain a LAMP buffer; a third chamber configured to contain a running buffer; a second housing portion defining at least one waste chamber configured to receive fluid from the first chamber, the second chamber, and the third chamber; a graphene heating element carried on the second housing portion; and a sliding panel comprising a sample chamber configured to receive the biological sample via the injection port, wherein the sliding panel is: positioned between the first housing portion and the second housing portion; and configured to move the sample chamber to different positions corresponding to at least the first chamber and the second chamber of the first housing portion, wherein the diagnostic device is configured to complete a diagnostic indication of a presence of a biological substance within the biological sample.

In one or more examples, the functions described herein, such as heating control of a heating element or control via a mobile device, may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and

Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A diagnostic system, the system comprising:
a first housing portion defining:
an injection port;
a first chamber configured to contain a first solution; and
a second chamber configured to contain a second solution;
a second housing portion defining at least one waste chamber configured to receive fluid from at least one of the first chamber or the second chamber; and
a sliding panel comprising a sample chamber configured to contain a biological sample, wherein the sliding panel is:
positioned between the first housing portion and the second housing portion; and
configured to move the sample chamber to different positions corresponding to at least the first chamber and the second chamber of the first housing portion.

2. The system of claim 1, further comprising a cover configured to enclose at least a portion of the first housing portion, the sliding panel, and the second housing portion.

3. The system of claim 1, further comprising at least a first fluid seal between the first housing portion and the sliding panel, and at least a second fluid seal between the second housing portion and the sliding panel.

4. The system of claim 1, wherein the at least one waste chamber comprises separate respective chambers for each of the first chamber and the second chamber.

5. The system of claim 1, wherein the first housing portion defines a viewing window extending fully through the first housing portion, wherein the sample associated with the sliding panel is exposed via the viewing window.

6. The system of claim 1, wherein the sample chamber comprises filter paper.

7. The system of claim 1, wherein the sliding panel comprises a handle configured to be grasped by a user, and wherein the handle is configured to move the sliding panel in response to movement of the handle by the user.

8. The system of claim 1, further comprising a heating element carried on the second housing portion.

9. The system of claim 8, wherein the heating element comprises a graphene heating element.

10. The system of claim 1, further comprising a third chamber configured to contain a third solution, wherein the waste chamber is configured to also receive fluid from the third chamber.

11. The system of claim 10, wherein the first solution comprises a wash buffer, the second solution comprises a LAMP buffer, and the third chamber comprises a running buffer.

12. The system of claim 1, wherein the system is configured to accept the biological sample to the sample chamber and complete a diagnostic indication of a presence of a biological substance within the biological sample.

13. The system of claim 1, further comprising an electrochemical sensor associated with the sample chamber, wherein the electrochemical sensor is configured to generate a detection signal indicative of a concentration of a biological substance of the biological sample.

14. A method comprising:
inserting a biological sample into a sample chamber of a diagnostic system, wherein the diagnostic system comprises:
a first housing portion defining:
an injection port;
a first chamber configured to contain a first solution; and
a second chamber configured to contain a second solution;
a second housing portion defining at least one waste chamber configured to receive fluid from at least one of the first chamber or the second chamber; and
a sliding panel comprising the sample chamber configured to contain the biological sample, wherein the sliding panel is positioned between the first housing portion and the second housing portion and configured to move the sample chamber to different positions corresponding to at least the first chamber and the second chamber of the first housing portion;
moving the sliding panel such that the sample chamber comes in contact with the first solution of the first chamber;
moving the sliding panel such that the sample chamber comes in contact with the second solution of the second chamber; and
positioning the sliding panel to expose the sample chamber for user viewing of a diagnostic result indicated by the sample chamber.

15. The method of claim 14, further comprising heating the sample chamber at a position corresponding to the first chamber.

16. The method of claim 14, wherein inserting the biological sample comprises applying the biological sample to filter paper retained within the sample chamber.

17. The method of claim 14, wherein the diagnostic system is configured to perform a polymerase chain reaction (PCR) process on the biological sample.

18. The method of claim 14, wherein the diagnostic system is configured to determine whether or not the biological sample is positive for COVID-19.

19. The method of claim 14, further comprising generating, by an electrochemical sensor associated with the sample chamber, a detection signal indicative of a concentration of a biological substance of the biological sample.

20. A diagnostic device comprising:
a first housing portion defining:
an injection port configured to accept a biological sample;
a first chamber configured to contain a wash buffer; and
a second chamber configured to contain a LAMP buffer;
a third chamber configured to contain a running buffer;
a second housing portion defining at least one waste chamber configured to receive fluid from the first chamber, the second chamber, and the third chamber;
a graphene heating element carried on the second housing portion; and
a sliding panel comprising a sample chamber configured to receive the biological sample via the injection port, wherein the sliding panel is:
positioned between the first housing portion and the second housing portion; and
configured to move the sample chamber to different positions corresponding to at least the first chamber and the second chamber of the first housing portion, wherein the diagnostic device is configured to complete a diagnostic indication of a presence of a biological substance within the biological sample.
